(19) United States
(12) Patent Application Publication
(10) Pub. No.: US 2026/0101281 A1
(43) Pub. Date: Apr. 9, 2026

(54) ITERATIVE DETECTION AND DECODING (IDD) CIRCUIT FOR CALCULATING LOW-POWER CONSUMPTION LOG-LIKELIHOOD RATIO, OPERATION METHOD OF THE IDD CIRCUIT, AND MODEM CHIP

(71) Applicant: SAMSUNG ELECTRONICS CO., LTD., Suwon-si (KR)

(72) Inventors: Joohan KIM, Suwon-si (KR); Jangho LEE, Suwon-si (KR); Youngseok JUNG, Suwon-si (KR)

(73) Assignee: SAMSUNG ELECTRONICS CO., LTD., Suwon-si (KR)

(21) Appl. No.: 19/239,332

(22) Filed: Jun. 16, 2025

(30) Foreign Application Priority Data
Oct. 8, 2024 (KR) 10-2024-0136798

(51) Int. Cl. H04W 52/02; H04B 7/0413

(52) U.S. Cl. CPC H04W 52/0209; H04B 7/0413

(57) ABSTRACT

Provided are an iterative detection and decoding (IDD) circuit, which includes a multiple-input and multiple-output (MIMO) detector having low power consumption, an operation method of the IDD circuit, and a modem chip. The IDD circuit, which is configured to receive a signal including a symbol, includes a first detector configured to generate a first log-likelihood ratio based on the symbol by using a linear detection method, a decoding circuit configured to perform a first decoding operation based on the first log-likelihood ratio and to generate a post-log-likelihood ratio when the first decoding operation fails, and a second detector configured to, when the first decoding operation fails, generate a second log-likelihood ratio based on the symbol and the post-log-likelihood ratio by using a nonlinear detection method, wherein the decoding circuit is further configured to perform a second decoding operation based on the second log-likelihood ratio.

### CROSS-REFERENCE TO RELATED APPLICATION

This application is based on and claims priority under 35 U.S.C. § 119 to Korean Patent Application No. 10-2024-0136798, filed on Oct. 8, 2024, in the Korean Intellectual Property Office, the disclosure of which is incorporated by reference herein in its entirety.

### BACKGROUND

The inventive concept relates to an iterative detection and decoding (IDD) circuit, and more particularly, to an IDD circuit including a multiple-input and multiple-output (MIMO) detector having low power consumption, an operation method of the IDD circuit, and a modem chip.

Recently, along with the rapid advancement of wireless and wired communication technologies and smart device-related technologies, required is high decoding accuracy of signals received by receivers in wireless communication systems.

In general, receivers may receive encoded signals from transmitters and may obtain information transmitted by transmitters by decoding reception signals. To decode reception signals, receivers may generate log-likelihood ratios. In the calculation of log-likelihood ratios, as modulation orders of reception signals and/or the number of layers of reception signals increase, the complexity of calculation of log-likelihood ratios may increase. Therefore, there is demand for a method of reducing the complexity of calculation of a log-likelihood ratio while preventing performance deterioration.

### SUMMARY

The inventive concept is for reducing the complexity and power consumption in an operation of generating a log-likelihood ratio for decoding a reception signal in a wireless communication system.

According to an aspect of the inventive concept, there is provided an iterative detection and decoding (IDD) circuit configured to receive a signal including a symbol, the IDD circuit including a first detector configured to generate a first log-likelihood ratio based on the symbol by using a linear detection method, a decoding circuit configured to perform a first decoding operation based on the first log-likelihood ratio and to generate a post-log-likelihood ratio when the first decoding operation fails, and a second detector configured to, when the first decoding operation fails, generate a second log-likelihood ratio based on the symbol and the post-log-likelihood ratio by using a nonlinear detection method, wherein the decoding circuit is further configured to perform a second decoding operation based on the second log-likelihood ratio.

According to another aspect of the inventive concept, there is provided an operation method of an iterative detection and decoding (IDD) circuit, the operation method including receiving a signal including a symbol and performing N iterative operations (where N is an integer of 2 or more), wherein a first iterative operation from among the N iterative operations includes generating a first log-likelihood ratio based on the symbol by using a linear detection method, performing a first decoding operation based on the first log-likelihood ratio, terminating the N iterative operations, when the first decoding operation is successful, and generating a post-log-likelihood ratio based on the first log-likelihood ratio, when the first decoding operation fails, and an N-th iterative operation from among the N iterative operations includes generating a second log-likelihood ratio based on the symbol and the post-log-likelihood ratio by using a nonlinear detection method, and performing a second decoding operation based on the second log-likelihood ratio.

According to another aspect of the inventive concept, there is provided a modem chip including a radio-frequency integrated circuit (RFIC) and a processor configured to receive, via the RFIC, a reception signal including a symbol, wherein the processor is further configured to generate a first log-likelihood ratio based on the symbol by using a linear detection method, perform a first decoding operation based on the first log-likelihood ratio, generate a post-log-likelihood ratio, when the first decoding operation fails, generate a second log-likelihood ratio based on the symbol and the post-log-likelihood ratio by using a nonlinear detection method, when the first decoding operation fails, and perform a second decoding operation based on the second log-likelihood ratio.

### BRIEF DESCRIPTION OF THE DRAWINGS

Brief descriptions of respective drawings are provided to gain a sufficient understanding of the drawings of the detailed description of the inventive concept.

Embodiments will be more clearly understood from the following detailed description taken in conjunction with the accompanying drawings in which:

FIG. 1 is a block diagram illustrating a wireless communication system according to an embodiment;

FIG. 2 is a block diagram illustrating a wireless communication device according to an embodiment;

FIG. 3 is a block diagram illustrating an iterative detection and decoding (IDD) circuit according to an embodiment;

FIG. 4 is a block diagram illustrating a multiple-input multiple-output (MIMO) detector according to an embodiment;

FIG. 5 is a flowchart illustrating an operation method of an IDD circuit, according to an embodiment;

FIG. 6 is a flowchart illustrating an operation method of an IDD circuit, according to an embodiment;

FIG. 7 is a graph illustrating a block error rate (BLER) performance of an IDD circuit, according to an embodiment;

FIG. 8 is a block diagram illustrating a transmitter according to an embodiment;

FIG. 9 is a block diagram illustrating a receiver according to an embodiment;

FIG. 10 is a block diagram illustrating a communication device according to an embodiment; and

FIG. 11 is a conceptual diagram illustrating an Internet-of-Things (IOT) network system to which an embodiment is applied.

### DETAILED DESCRIPTION OF THE EMBODIMENTS

Hereinafter, embodiments of the inventive concept will be described in detail with reference to the accompanying drawings.

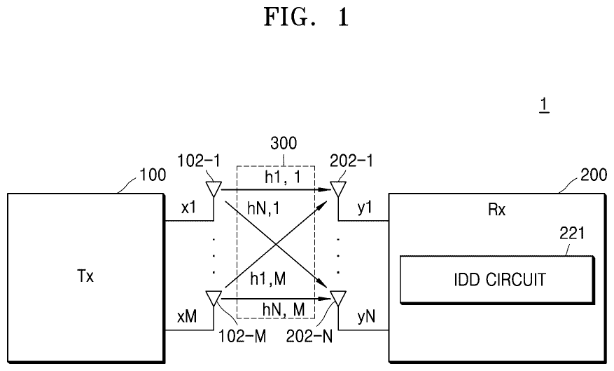

FIG. 1 is a block diagram illustrating a wireless communication system according to the inventive concept.

Referring to FIG. 1, a wireless communication system 1 may include a transmitter 100 and a receiver 200, which communicate with each other via a multiple-input and multiple-output (MIMO) channel 300.

The wireless communication system 1 may include any system including the MIMO channel 300. In some embodiments, the wireless communication system 1 may include, as a non-limiting example, a wireless communication system, such as a 5th-generation (5G) wireless system, a Long-Term Evolution (LTE) system, or a WiFi system. In some embodiments, the wireless communication system 1 may include a wireless communication system, such as a storage system or a network system. Hereinafter, the wireless communication system 1 is described as a wireless communication system, but embodiments of the inventive concept are not limited thereto.

For example, the transmitter 100 may include a base station or a component that is included in the base station. The base station may refer to a fixed station communicating with a terminal and/or another base station and may transmit and receive data and/or control information to and from a terminal and/or another base station by communicating with the terminal and/or the other base station. The base station may also be referred to as a Node B, an evolved-Node B (eNB), a base transceiver system (BTS), an access point (AP), or the like.

For example, the receiver 200 may include a terminal or a component that is included in the terminal. For example, the receiver 200 may include a modem chip. The terminal, which is a wireless communication device, may refer to various devices capable of transmitting and receiving data and/or control information to and from the transmitter 100 by communicating with the transmitter 100. For example, the terminal may be referred to as a user equipment, a mobile station (MS), a mobile terminal (MT), a user terminal (UT), a subscribe station (SS), a wireless device, a portable device, or the like.

A wireless communication network between the transmitter 100 and the receiver 200 may support a large number of users to communicate with each other by sharing available network resources. For example, in the wireless communication network, information may be transferred by various methods, such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), and the like.

The transmitter 100 may include a plurality of transmission antennas 102-1 to 102-M (where M is a positive integer) and may transmit a signal including a plurality of symbols x1 to xM via each of the plurality of transmission antennas 102-1 to 102-M. In addition, the receiver 200 may include a plurality of reception antennas 202-1 to 202-N (where N is a positive integer) and may receive a signal including a plurality of symbols y1 to yN via each of the plurality of reception antennas 202-1 to 202-N.

For example, when a symbol vector transmitted by the transmitter 100 is represented by x=[x1, . . . xM]^{T}, a symbol vector y received by the receiver 200 may be represented by Equation 1 shown below.

$$y = Hx + n = ( \begin{matrix}h 1 , 1 & ⋯ & h 1 , j & ⋯ & h 1 , M \\ ⋮ & ⋱ & ⋮ & ⋱ & ⋮ \\ hi , 1 & ⋯ & hi , j & ⋯ & hi , M \\ ⋮ & ⋱ & ⋮ & ⋱ & ⋮ \\ hN , 1 & ⋯ & hN , j & ⋯ & hN , M\end{matrix} ) ( \begin{matrix}x 1 \\ ⋮ \\ xj \\ ⋮ \\ xM\end{matrix} ) + ( \begin{matrix}n 1 \\ ⋮ \\ nj \\ ⋮ \\ nM\end{matrix} ) \qquad [ Equation 1 ]$$

In Equation 1, hi,j may represent an effective channel gain between a j-th transmission antenna (or transmission layer) (where j is an integer of 1 to M) and an i-th reception antenna (where i is an integer of 1 to N), and xj may represent a transmission symbol from the j-th transmission antenna (or transmission layer).

The transmission symbol xj may be a value of one of signal constellation points. A constellation point may refer to a point on a complex plane used for mapping a transmission signal. The number and positions of constellation points on the complex plane may vary with a modulation method. A particular modulation method may be determined by a modulation order. That is, a modulation method of a transmission signal may be determined based on a modulation order, and when the modulation order increases, the number of constellation points according to the modulation method corresponding thereto may increase. For example, when the transmitter 100 modulates a transmission signal by a Quadrature Phase Shift Keying (QPSK) method, one constellation point may be located in each quadrant of the complex plane. That is, four constellation points may be used to modulate the transmission signal. The transmitter 100, which modulates a transmission signal by the QPSK method, may map the transmission signal to one of the four constellation points and may transmit the transmission signal to the receiver 200. For convenience of description, although descriptions are made herein under the premise that the modulation method of the transmitter 100 is the QPSK method, the modulation method of the transmitter 100 is not limited thereto and the transmission signal may be modulated by a 16QAM, 64QAM, 256QAM, or 1024QAM method.

In addition, in Equation 1, ni represents additive white Gaussian noise (AWGN) from the i-th reception antenna and may have power (or a variance) of σ². An interference signal may be included in the AWGN. For example, in the wireless communication system 1, noise of a reception antenna may be taken into account together with an influence of an interference signal. In this case, although variances of the AWGN for the respective reception antennas 202-1 to 202-N may be different and spatially correlated, it is assumed hereinafter that pieces of power of the AWGN for the respective reception antennas 202-1 to 202-N are equal and spatially uncorrelated. In this case, the AWGN may be equal to noise having undergone the application of a whitening filter.

The receiver 200 may receive a signal including a symbol and may perform a detection operation for generating (or calculating) a log-likelihood ratio (LLR) based on the received symbol and a decoding operation for decoding the received signal based on the generated LLR. In a MIMO system, to generate an LLR, the receiver 200 may perform a detection operation by using a linear detection method or a nonlinear detection method.

The linear detection method may refer to a detection method having relatively low complexity for LLR generation and may include a method of generating an LLR by using a linear detection matrix. For example, the linear detection method may include a method of generating an LLR by using a linear detection matrix including at least one of a minimum mean square error (MMSE) weight matrix, a zero forcing (ZF) weight matrix, and a QR decomposition (QRD) weight matrix.

The nonlinear detection method may refer to a detection method having relatively high complexity for LLR generation. For example, the nonlinear detection method may include a method of generating an LLR by using at least one of a maximum likelihood (ML) algorithm and a near-ML algorithm. The near-ML algorithm may include a K-best algorithm or sphere decoding.

Although the linear detection method may have relatively low power consumption in a detection operation due to relatively low complexity for LLR generation as compared with the nonlinear detection method, the linear detection method may have an accompanying performance deterioration. For example, when the receiver 200 performs a detection operation by using only the linear detection method, block error ratio (BLER) performance may be reduced.

A decoding operation may refer to an operation of decoding a corresponding bit based on an LLR. For example, when the LLR is a negative number, the corresponding bit may be decoded into “0” out of “1” and “0”, and when the LLR is a positive number, the corresponding bit may be decoded into “1”. However, this is only an example, and the inventive concept is not limited thereto. A resulting value according to the decoding operation may refer to a soft value indicating the probability that a reception signal is decoded into “0” or “1”.

The receiver 200 according to the inventive concept may include an iterative detection and decoding (IDD) circuit 221. To improve the performance of a detection operation, the IDD circuit 221 may perform N iterative operations (where N is an integer of 2 or more) each including a detection operation and a decoding operation. The N iterative operations may be referred to as IDD operations or IDD methods. For example, a detection operation of an m-th iterative operation (where m is an integer of 2 to N) may refer to an operation of generating an LLR based on a received symbol and an output (for example, a post-log-likelihood ratio) generated in a decoding operation of an m-1-th iterative operation.

In some embodiments, when the IDD circuit 221 performs N iterative operations, a first iterative operation from among the N iterative operations may include an operation of generating a first LLR based on a received symbol by using a linear detection method and performing a first decoding operation based on the first LLR. The last iterative operation (or an N-th iterative operation) from among the N iterative operations may include an operation of generating a second LLR based on the received symbol and an output (for example, a post-log-likelihood ratio) generated in a decoding operation of an N-1-th iterative operation by using a nonlinear detection method and performing a second decoding operation based on the second LLR. Therefore, because the IDD circuit 221 uses the linear detection method having relatively low complexity for LLR generation in the first iterative operation and uses the nonlinear detection method having relatively high complexity for LLR generation in the last iterative operation, the IDD circuit 221 may reduce the power consumption and complexity in an initial detection operation and may prevent performance deterioration in the initial detection operation.

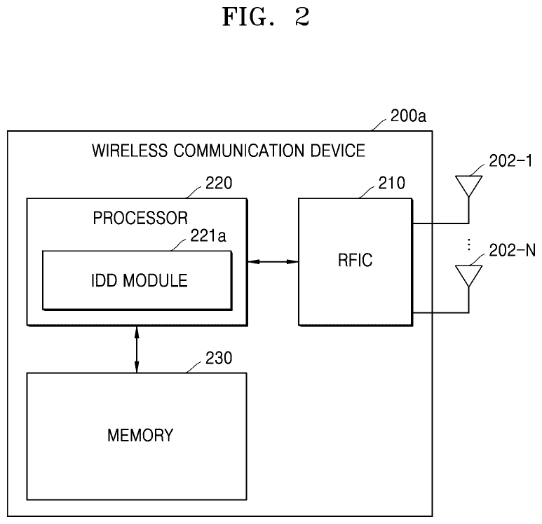

FIG. 2 is a block diagram illustrating a wireless communication device according to an embodiment. A wireless communication device 200a of FIG. 2 may correspond to the receiver 200 (see FIG. 1) described with reference to FIG. 1, and repeated descriptions are omitted.

Referring to FIG. 2, the wireless communication device 200a according to the inventive concept may include a radio-frequency integrated circuit (RFIC) 210, a processor 220, a memory 230, and a plurality of antennas 202-1 to 202-N. The wireless communication device 200a may further include various components in addition to the components shown in FIG. 2. An RFIC and a processor may be included in one modem chip. The wireless communication device 200a according to the inventive concept may include a modem chip, and depending on embodiments, the modem chip may perform operations performed by the wireless communication device 200a. The wireless communication device 200a may access a wireless communication system by transmitting and receiving signals via at least one of the plurality of antennas 202-1 to 202-N.

The RFIC 210 may transmit and receive symbol vectors via at least one of the plurality of antennas 202-1 to 202-N. That is, at least some of the plurality of antennas 202-1 to 202-N may each correspond to a transmission antenna. The transmission antenna may transmit a signal to an external device (for example, another wireless communication device or a base station (BS)) rather than to the wireless communication device 200a. The remaining antennas from among the plurality of antennas 202-1 to 202-N may each correspond to a reception antenna. The reception antenna may receive a radio signal from the external device.

The processor 220 may control all operations of the wireless communication device 200a, and as an example, the processor 220 may include a central processing unit (CPU). The processor 220 may include one processor core (that is, a single core) or a plurality of processor cores (that is, multi-cores). The processor 220 may process or execute programs and/or data stored in the memory 230. In an embodiment, the processor 220 may execute programs stored in the memory 230, thereby controlling various functions of the wireless communication device 200a or performing various operations.

The processor 220 according to the inventive concept may include an IDD module 221a. The IDD module 221a may correspond to the IDD circuit 221 of FIG. 1. The IDD module 221a may include processing circuitry, such as hardware including a logic circuit, a hardware-software combination, such as a processor configured to execute software, or a combination thereof. For example, more specifically, the processing circuitry may include, but is not limited to, an arithmetic logic unit (ALU), a digital signal processor, a microcomputer, a field-programmable gate array (FPGA), a microprocessor, an application-specific integrated circuit (ASIC), or the like.

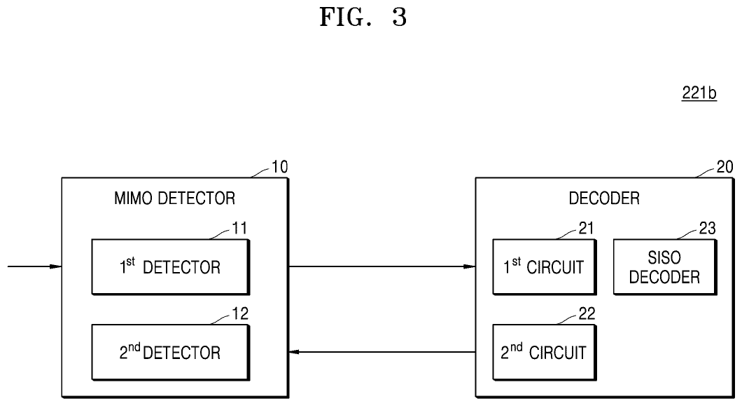

In some embodiments, the wireless communication device 200a includes an RFIC 210 and a processor 220 configured to receive a reception signal via the RFIC 210. The wireless communication device 200a may include a modem chip. The processor 220 may generate a first LLR based on a symbol in a reception signal by using a linear detection method, may perform a first decoding operation based on the first LLR, may generate, when the first decoding operation fails, a post-log-likelihood ratio and generate a second LLR based on the symbol and the post-log-likelihood ratio by using a nonlinear detection method, and may perform a second decoding operation based on the second LLR. Embodiments when a decoding operation fails are described below with reference to FIG. 3.

In some embodiments, the processor 220 may perform N iterative operations (where N is an integer of 2 or more) each including a detection operation and a decoding operation to improve the performance of the detection operation. For example, when N is 2, a first iterative operation may include a first detection operation for generating a first LLR and a first decoding operation for decoding the first LLR, and a second iterative operation may include a second detection operation for generating a second LLR based on a symbol and on a post-log-likelihood ratio generated in the first decoding operation, and a second decoding operation for decoding the second LLR. Because the processor 220 uses a linear detection method having relatively low complexity for LLR generation in the first iterative operation and uses a nonlinear detection method having relatively high complexity for LLR generation in the last iterative operation, the processor 220 may reduce the power consumption and complexity in an initial detection operation and may prevent performance deterioration in the initial detection operation.

FIG. 3 is a block diagram illustrating an IDD circuit according to an embodiment. An IDD circuit 221b of FIG. 3 may correspond to the IDD circuit 221 (see FIG. 1) described with reference to FIG. 1, and repeated descriptions are omitted.

Referring to FIG. 3, the IDD circuit 221b may include a MIMO detector 10 and a decoder 20. The MIMO detector 10 may include a first detector 11 and a second detector 12. The first detector 11 may be configured to generate an LLR by using a linear detection method, and the second detector 12 may be configured to generate an LLR by using a nonlinear detection method.

The decoder 20 may include a first circuit 21, a second circuit 22, and a soft-in and soft-out (SISO) decoder 23. A configuration of the decoder 20 is not limited thereto, and the first circuit 21 and the second circuit 22 may be located outside the decoder 20.

In some embodiments, the IDD circuit 221b may perform N iterative operations (where N is an integer of 2 or more), and a first iterative operation from among the N iterative operations may include a first detection operation and a first decoding operation.

For example, in the first iterative operation, the first detector 11 may receive a signal (for example, a signal received by the receiver 200 of FIG. 1) including a symbol. The first detector 11 may perform the first detection operation for generating a first LLR based on the symbol of the received signal by using a linear detection method and may transmit the generated first LLR to the decoder 20. The linear detection method may include a method of generating an LLR by using a linear detection matrix including at least one of an MMSE weight matrix, a ZF weight matrix, and a QRD weight matrix.

For example, in the first iterative operation, the decoder 20 may perform the first decoding operation based on the first LLR that is received. The first circuit 21 may generate a first pre-log-likelihood ratio by performing a de-interleaving operation and a rate de-matching operation on the first LLR. The de-interleaving operation may refer to an opposite operation to an interleaving operation, and the interleaving operation may refer to an operation of changing the position of a signal (or data) and transmitting the signal to facilitate error correction. The rate de-matching operation may refer to an opposite operation to a rate matching operation, and the rate matching operation may refer to an operation of matching a signal (or data) to the number of modulation symbols that are allocated. The SISO decoder 23 may receive the first pre-LLR from the first circuit 21 and may perform the first decoding operation for decoding the first pre-LLR.

In some embodiments, the SISO decoder 23 may determine whether the first decoding operation will fail. For example, the SISO decoder 23 may output a soft value indicating the probability that a reception signal is decoded into “0” or “1”. The SISO decoder 23 may further perform a cyclic redundancy check (CRC) operation and, when the CRC operation fails, may determine that decoding will fail.

In some embodiments, when the first decoding operation fails, the SISO decoder 23 may generate a post-LLR based on the first pre-LLR, and the second circuit 22 may generate a third LLR by performing an interleaving operation and a rate matching operation on the post-LLR. While the IDD circuit 221b is performing the N iterative operations, the post-LLR may be used by the MIMO detector 10 to remove interference in a reception signal or may be used to generate the second LLR.

In some embodiments, when the SISO decoder 23 succeeds in the first decoding operation, the IDD circuit 221b may terminate the N iterative operations. For example, when the SISO decoder 23 succeeds in the first decoding operation, the IDD circuit 221b may omit iterative operations subsequent to the first iterative operation.

In some embodiments, the last iterative operation from among the N iterative operations may include a second detection operation and a second decoding operation. For example, in the last iterative operation, the second detector 12 may receive a signal (for example, a signal received by the receiver 200 of FIG. 1) including a symbol and may receive the third LLR from the second circuit 22. The second detector 12 may perform a second detection operation for generating a second LLR based on the symbol of the received signal and on the third LLR by using a nonlinear detection method and may transmit the generated second LLR to the decoder 20. The nonlinear detection method may include a method of generating an LLR by using at least one of an ML algorithm and a near-ML algorithm.

For example, in the last iterative operation, the decoder 20 may perform a second decoding operation based on the second LLR that is received. The first circuit 21 may generate a second pre-LLR by performing a de-interleaving operation and a rate de-matching operation on the second LLR. The SISO decoder 23 may receive the second pre-LLR from the first circuit 21 and may perform the second decoding operation for decoding the second pre-LLR.

In some embodiments, second to N-1-th iterative operations from among the N iterative operations may each include a third detection operation and a third decoding operation. For example, the first detector 11 may receive, from the second circuit 22, an LLR (for example, the third LLR) corresponding to a decoding operation output of a directly previous iterative operation, may perform the third detection operation for generating a fourth LLR based on a symbol of a received signal and on the LLR corresponding to the output of the decoding operation of the directly previous iterative operation, and may transmit the generated fourth LLR to the decoder 20. The decoder 20 may perform the third decoding operation based on the fourth LLR that is received. The third decoding operation may be similar to the first decoding operation. In this case, the LLR corresponding to the decoding operation output of the directly previous iterative operation may be used by the first detector 11 to remove interference in a reception signal. However, the inventive concept is not limited thereto, and the third detection operation may include an operation of generating, by the second detector 12, an LLR by using a nonlinear detection method.

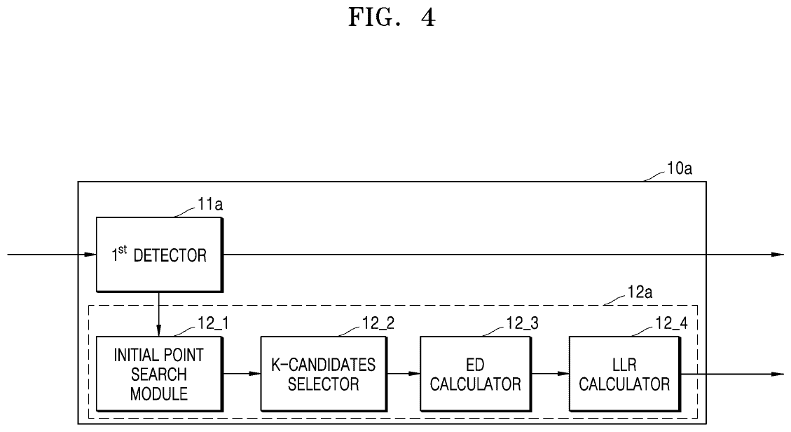

FIG. 4 is a block diagram illustrating a MIMO detector according to an embodiment. A MIMO detector 10a of FIG. 4 may correspond to the MIMO detector 10 (see FIG. 3) described with reference to FIG. 4, and repeated descriptions are omitted.

Referring to FIG. 4, the MIMO detector 10a may include a first detector 11a and a second detector 12a. The first detector 11a may correspond to the first detector 11 of FIG. 3. Although it is described hereinafter that the first detector 11a generates an LLR by a method using an MMSE weight matrix from among linear detection methods and that the second detector 12a generates an LLR by a K-best algorithm from among nonlinear detection methods, the inventive concept is not limited thereto. For example, the first detector 11a may use a linear detection method using a weight matrix other than the MMSE weight matrix, and the second detector 12a may use a nonlinear detection method other than the K-best algorithm.

In some embodiments, the second detector 12a may include an initial point search module 12_1, a K-candidates selector 12_2, a Euclidean distance (ED) calculator 12_3, and an LLR calculator 12_4. The second detector 12a may perform a second detection operation of the last iterative operation from among the N iterative operations by using the first detector 11a.

For example, the first detector 11a may receive a reception signal from a transmitter (for example, 100 of FIG. 1), and the reception signal may be represented by Equation 2 shown below.

$${y}_{j} = {H}_{i} {x}_{i} + {n}_{i} \qquad [ Equation 2 ]$$

In Equation 2, y is a reception signal vector, H is a channel matrix in the frequency domain, x is a transmission signal vector, and i is a subcarrier index. The first detector 11a may transmit a reception signal and an MMSE weight matrix to the initial point search module 12_1, based on the reception signal, and the MMSE weight matrix may be represented by Equation 3 shown below.

$${W}_{i} = {( {H}_{i} {H}_{i}^{H} + {σ}_{n}^{2} I )}^{- 1} {H}_{i}^{H} \qquad [ Equation 3 ]$$

In Equation 3, W is a linear detection matrix, H is a channel matrix, I is a unit matrix,

$${σ}_{n}^{2}$$

is a noise variance, and H^{H} is a hermitian matrix of the channel matrix H. i is a subcarrier index. The initial point search module 12_1 may search for an initial point based on a weight matrix. The initial point search module 12_1 may search for an initial point by Equation 4.

$${z}_{i} = {W}_{i} {y}_{i} + {W}_{i} {n}_{i} \qquad [ Equation 4 ]$$

In Equation 4, z represents an initial point, W represents an MMSE weight matrix, y represents a reception signal vector, n represents noise, and i represents a subcarrier index. Herein, the initial point may be referred to as a reference symbol.

The K-candidates selector 12_2 may select K constellation points adjacent to the initial point. In some embodiments, the K-candidates selector 12_2 may select K constellation points based on a signal-to-interference ratio (SIR). The ED calculator 12_3 may calculate EDs between K candidates selected by the K-candidates selector 227 and the initial point. The LLR calculator 12_4 may calculate an LLR based on the EDs calculated by the ED calculator 12_3. The LLR calculator 12_4 may calculate an LLR based on MAX-LOG-MAP. The LLR calculator 12_4 may calculate an LLR by Equation 5 shown below.

$$L ( {b}_{l} ) = log \frac{{max}_{x : {b}_{l} = 0} {e}^{- \frac{{‖ y - Hx ‖}^{2}}{{σ}^{2}}}}{{max}_{x : {b}_{l} = 1} {e}^{- \frac{{‖ y - Hx ‖}^{2}}{{σ}^{2}}}} = {max}_{{b}_{l} = 0} ( - \frac{{‖ y - Hx ‖}^{2}}{{σ}^{2}} + {\sum }_{l \neq m} {L}_{A} ( {b}_{l} ) ) - {max}_{{b}_{l} = 1} ( - \frac{{‖ y - Hx ‖}^{2}}{{σ}^{2}} + {\sum }_{l \neq m} {L}_{A} ( {b}_{l} ) ) \qquad [ Equation 5 ]$$

In Equation 5, bₗ may refer to an 1-th bit (where 1 is an integer) of a symbol, and L(bₗ) may refer to a second LLR generated by the second detector 12a. L_{A}(bₗ) may refer to a decoding operation output (for example, a post-log-likelihood ratio) of the N-1-th iterative operation, and Σ_{l≠m} may refer to the sum for the remaining ones except for m. For example, when 1 has a value of 0 to 7 and m is 0, Σ_{l≠m} may refer to the sum of values corresponding to 1 to 7.

Because the second detector 12a according to the inventive concept may perform a second detection operation of the last iterative operation from among the N iterative operations by using the first detector 11a, when the second detector 12a is implemented, an additional component corresponding to the first detector 11a may be omitted.

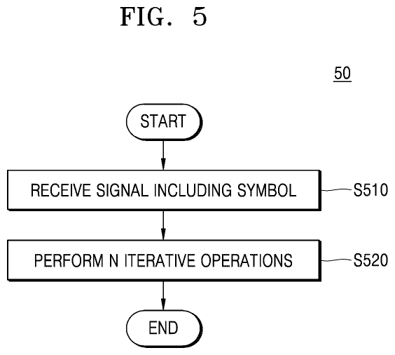

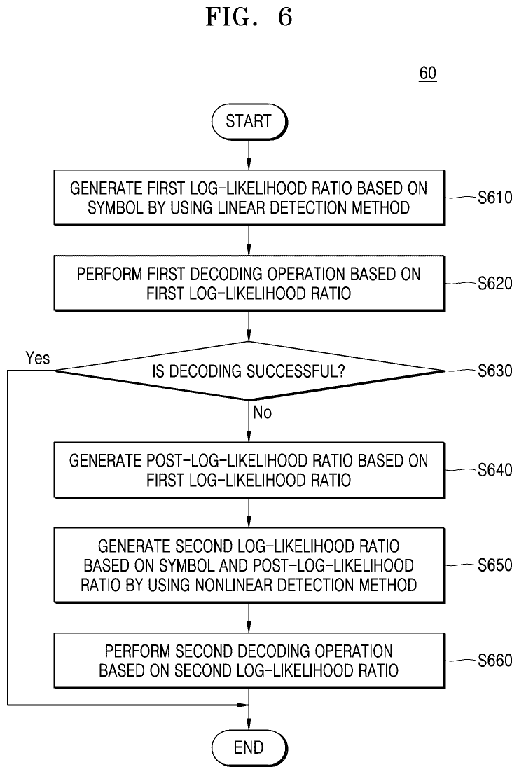

FIG. 5 is a flowchart illustrating an operation method of an IDD circuit, according to an embodiment. FIG. 6 is a flowchart illustrating an operation method of an IDD circuit, according to an embodiment. Referring to FIG. 5, an operation method 50 of an IDD circuit may include a plurality of operations S510 and S520.

Referring further to FIG. 3, in operation S510, the MIMO detector 10 may receive a signal including a symbol. In some embodiments, the MIMO detector 10 may receive a signal transmitted by the receiver 200 of FIG. 1.

In operation S520, the IDD circuit 221b may perform N iterative operations. In some embodiments, the IDD circuit 221b may perform N iterative operations (where N is an integer of 2 or more) each including a detection operation for generating an LLR and a decoding operation for decoding the generated LLR.

Referring further to FIG. 6, an operation method 60 of an IDD circuit may include a plurality of operations S610 to S660 and may be an example when N corresponding to operation S520 is 2. Although descriptions are made below under the assumption that N is 2, the inventive concept is not limited thereto. For example, N may be an integer of 3 or more.

In operation S610, the first detector 11 may generate a first LLR based on a symbol by using a linear detection method. In some embodiments, the first detector 11 may receive a signal (for example, a signal received by the receiver 200 of FIG. 1) including a symbol. The first detector 11 may generate the first LLR based on the symbol of the received signal by using the linear detection method and may transmit the generated first LLR to the decoder 20. The linear detection method may include a method of generating an LLR by using a linear detection matrix including at least one of an MMSE weight matrix, a ZF weight matrix, and a QRD weight matrix.

In operation S620, the decoder 20 may perform a first decoding operation based on the first LLR. In some embodiments, the decoder 20 may perform the first decoding operation for decoding a corresponding bit based on the first LLR. For example, the decoder 20 may decode the corresponding bit into 0 when the first LLR is a negative number and may decode the corresponding bit into 1 when the first LLR is a positive number. Alternatively, the decoder 20 may output a soft value indicating the probability of being decoded according to the first LLR.

In operation S630, the decoder 20 may determine whether a decoding operation is successful. For example, when the soft value is unable to be output, the decoder 20 may determine that decoding will fail. For example, the decoder 20 may further perform a CRC operation and, when the CRC operation fails, may determine that decoding will fail.

When it is determined in operation S630 that the decoding operation will succeed, the N iterative operations may be terminated without performing a second iterative operation.

When it is determined in operation S630 that the decoding operation will fail, the decoder 20 may generate a post-LLR based on the first LLR, in operation S640.

In operation S650, the second detector 12 may generate a second LLR based on the symbol and the post-LLR by using a nonlinear detection method. In some embodiments, the second detector 12 may receive the signal (for example, the signal received by the receiver 200 of FIG. 1) including the symbol and may receive the post-LLR from the decoder 20. The second detector 12 may generate the second LLR based on the symbol of the received signal and on the post-LLR by using the nonlinear detection method and may transmit the generated second LLR to the decoder 20. The nonlinear detection method may include a method of generating an LLR by using at least one of an ML algorithm and a near-ML algorithm.

In operation S660, the decoder 20 may perform a second decoding operation based on the second LLR. For example, the decoder 20 may decode a corresponding bit into 0 when the second LLR is a negative number and may decode the corresponding bit into 1 when the second LLR is a positive number. Alternatively, the decoder 20 may output a soft value indicating the probability of being decoded according to the second LLR.

Operations S610 to S640 may correspond to a first iterative operation out of two iterative operations, and operations S650 and S660 may correspond to a second iterative operation that is the last iterative operation out of the two iterative operations.

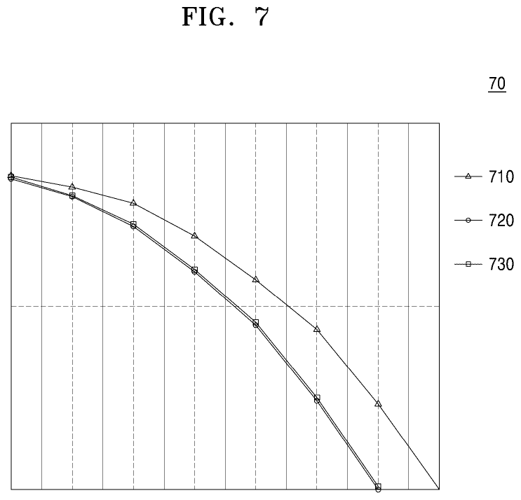

FIG. 7 is a graph illustrating a BLER performance of an IDD circuit, according to an embodiment.

Referring to FIG. 7, the horizontal axis of a graph 70 illustrating the BLER performance of the IDD circuit may represent a carrier-to-noise ratio (CNR, unit:dB), and the vertical axis of the graph 70 may represent throughput (unit:kbps).

A first comparative example 710 may illustrate a BLER performance of a nonlinear detector when an IDD operation is not applied, and a second comparative example 720 may illustrate a BLER performance of a detector when an IDD operation is applied by using only a nonlinear detection method. An embodiment 730 of the inventive concept may illustrate a BLER performance when, while an IDD operation is applied, a linear detection method having relatively low complexity for LLR generation is used in a first iterative operation and a nonlinear detection method having relatively high complexity for LLR generation is used in the last iterative operation. The BLER performance may be relatively better as the shape of a graph moves to the lower left side, and thus, it may be confirmed that the embodiment 730 of the inventive concept prevents performance deterioration.

In other words, because the embodiment 730 of the inventive concept uses a linear detection method having relatively low complexity for LLR generation in the first iterative operation and uses a nonlinear detection method having relatively high complexity for LLR generation in the last iterative operation, performance deterioration in an initial detection operation may be prevented while reducing the power consumption and complexity in the initial detection operation.

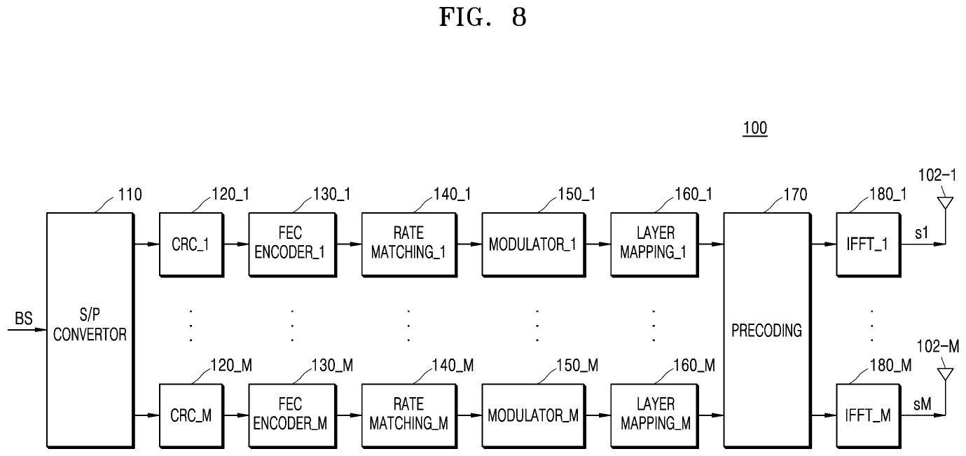

FIG. 8 is a block diagram illustrating a transmitter according to an embodiment.

FIG. 8 may illustrate, for example, components that are included in the transmitter 100 of FIG. 1.

Referring to FIG. 8, the transmitter 100 may include a serial-to-parallel (S/P) converter 110, a plurality of CRC units 120_1 to 120_M, a plurality of forward error correction (FEC) encoders 130_1 to 130_M, a plurality of rate matching units 140_1 to 140_M, a plurality of modulators 150_1 to 150_M, a plurality of layer mapping units 160_1 to 160_M, a precoding unit 170, a plurality of inverse fast Fourier transform (IFFT) units 180_1 to 180_M, and a plurality of antennas 102-1 to 102-M.

First, an information bit stream BS, which is an object to be transmitted, may be input to the S/P converter 110. The S/P converter 110 may generate a plurality of information bit streams by parallel-converting the input information bit stream BS and may respectively output the information bit streams to the CRC units 120_1 to 120_M. For example, the S/P converter 110 may parallel-convert the information bit stream BS into codewords (or transport blocks), which are units of channel decoding inputs, and may output the codewords.

The plurality of CRC units 120_1 to 120_M may respectively add CRC bits to the parallel-converted bit streams (for example, codewords), and then, may respectively output signals having the added CRC bits to the plurality of FEC encoders 130_1 to 130_M.

The plurality of FEC encoders 130_1 to 130_M may use FEC, which is an error correction code for correcting an error occurring due to noise, for the signals received from the plurality of CRC units 120_1 to 120_M, respectively. For example, in a wireless communication system, at least one of a convolution code, a turbo code, a low-density parity-check (LDPC) code, and a polar code may be used as the FEC.

The plurality of rate matching units 140_1 to 140_M may respectively perform rate matching operations on the signals output from the plurality of FEC encoders 130_1 to 130_M, based on a preset rate matching method, and may respectively output the signals having undergone the rate matching operations to the plurality of modulators 150_1 to 150_M. Through the rate matching operations, the plurality of rate matching units 140_1 to 140_M may each match encoded bits to the number of modulation symbols allocated to each user.

The plurality of modulators 150_1 to 150_M may respectively perform modulation operations on the rate-matched signals, based on a preset modulation method, and may respectively output the signals having undergone the modulation operations to the plurality of layer mapping units 160_1 to 160_M. For example, the plurality of modulators 150_1 to 150_M may respectively map the rate-matched signals to signal constellation points. The plurality of layer mapping units 160_1 to 160_M may respectively distribute the modulated signals to be consistent with the number of input layers of the precoding unit 170.

The precoding unit 170 may perform a precoding operation on the signal output from each of the layer mapping units 160_1 to 160_M, based on a preset precoding method, and may output the resulting signals to the plurality of IFFT units 180_1 to 180_M, respectively. For example, the precoding method may be generated based on feedback information received by the transmitter 100. The plurality of IFFT units 180_1 to 180_M may each transform a transmission signal, which is output from the precoding unit 170, for each transmission antenna in the frequency domain into the time domain through IFFT and may respectively transfer transformed transmission signals s1 to sM to the antennas 102-1 to 102-M.

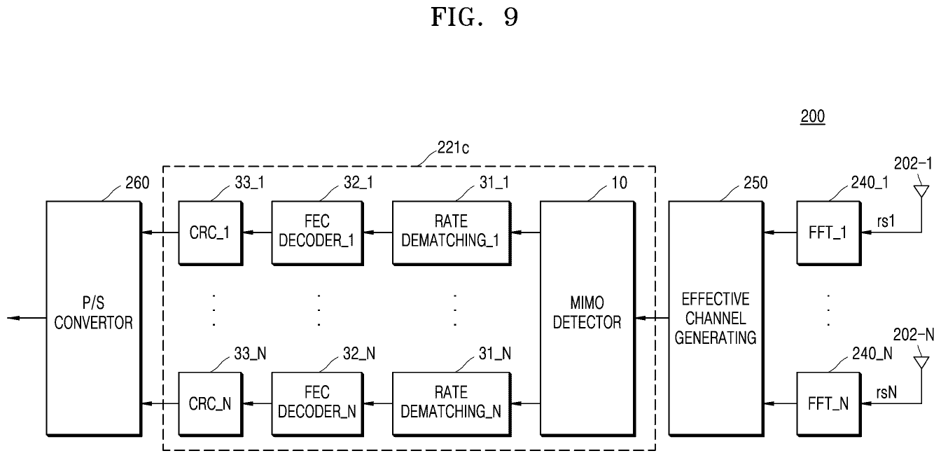

FIG. 9 is a block diagram illustrating a receiver, according to an embodiment.

FIG. 9 may be, for example, a block diagram of components that are included in the receiver 200 of FIG. 1.

Referring to FIG. 9, the receiver 200 may include a plurality of antennas 201-1 to 202-N, a plurality of fast Fourier transform (FFT) units 240_1 to 240_N, an effective channel generating unit 250, an IDD circuit 221c, and a parallel-to-serial (P/S) converter 260.

First, signals rs1 to rsN received through the plurality of antennas 201-1 to 202-N may be respectively input to the plurality of FFT units 240_1 to 240_N, and the plurality of FFT units 240_1 to 240_N may respectively perform FFT operations on the signals rs1 to rsN. That is, each of the plurality of FFT units 240_1 to 240_N may transform a reception signal for each antenna in the time domain into the frequency domain through FFT and may transfer the transformed reception signal to the effective channel generating unit 250.

The effective channel generating unit 250 may reflect influences due to the precoding method, which is applied by the transmitter 100, on the reception signals rs1 to rsM transformed into the frequency domain and may output the resulting signals to the IDD circuit 221c. Although, in the present embodiment, the receiver 200 includes the effective channel generating unit 250 to reflect the influences of the precoding method applied by the transmitter 100, the receiver 200 may not include the effective channel generating unit 250 in another embodiment. For example, when precoding is applied even to a reference signal, the receiver 200 may not include the effective channel generating unit 250.

The IDD circuit 221c may perform a demodulation operation on the signals output from the effective channel generating unit 250, based on a demodulation method corresponding to the modulation method used by the transmitter 100. For example, the IDD circuit 221c may generate an LLR by using an effective channel generated by the effective channel generating unit 250 and the reception signals rs1 to rsM.

The IDD circuit 221c may include a MIMO detector 10, a plurality of rate de-matching units 31_1 to 31_N, a plurality of FEC decoders 32_1 to 32_N, and a plurality of CRC units 33_1 to 33_N. The IDD circuit 221c according to the inventive concept may perform the N iterative operations described above with reference to FIGS. 1 to 7.

In some embodiments, each of the plurality of rate de-matching units 31_1 to 31_N may perform a rate de-matching operation on a signal output from the MIMO detector 10, based on a rate de-matching method corresponding to the rate matching method used by the transmitter 100. The FEC decoders 32_1 to 32_N may respectively perform decoding operations on the signals output from the rate de-matching units 31_1 to 31_N, based on an FEC decoding method corresponding to the FEC encoding method used by the transmitter 100. Each of the FEC decoders 32_1 to 32_N according to the inventive concept may decode a reception signal based on the LLR provided by the MIMO detector 10. The CRC units 33_1 to 33_N may respectively perform CRC operations on signals output from the FEC decoders 32_1 to 32_N and may output the signals having undergone the CRC operations to the P/S converter 260. The P/S converter 260 may serial-convert and output the signals output from the CRC units 33_1 to 33_N.

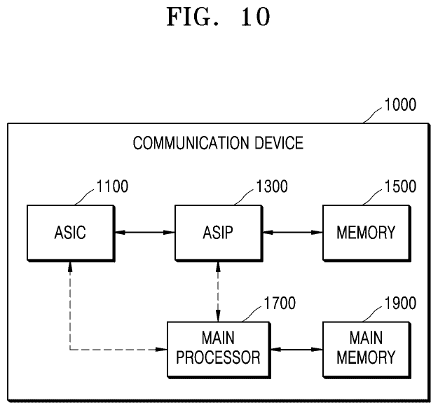

FIG. 10 is a block diagram illustrating a communication device according to an embodiment.

A communication device 1000 of FIG. 10 may correspond to the wireless communication device 200a of FIG. 2, and repeated descriptions are omitted.

Referring to FIG. 10, the communication device 1000 may include an ASIC 1100, an application-specific instruction set processor (ASIP) 1300, a memory 1500, a main processor 1700, and a main memory 1900. At least two of the ASIC 1100, the ASIP 1300, and the main processor 1700 may communicate with each other. In addition, at least two of the ASIC 1100, the ASIP 1300, the memory 1500, the main processor 1700, and the main memory 19500 may be embedded in a single chip. For example, as described above, at least two of the ASIC 1100, the ASIP 1300, the memory 1500, the main processor 1700, and the main memory 1900 may be included in a single modem chip.

The ASIP 1300, which is an integrated circuit customized for a particular use, may support a dedicated instruction set for a particular application and may execute instructions that are included in the instruction set. The memory 1500 may communicate with the ASIP 1300 and, as a non-transitory storage device, may store a plurality of instructions executed by the ASIP 1300. For example, the memory 1500 may include, as non-limiting examples, any type of memory capable of being accessed by the ASIP 1300, such as random-access memory (RAM), read-only memory (ROM), tape, a magnetic disk, an optical disk, volatile memory, nonvolatile memory, and a combination thereof.

The main processor 1700 may control the communication device 1000 by executing a plurality of instructions. For example, the main processor 1700 may control the ASIC 1100 and the ASIP 1300 and may process received data or process a user input to the communication device 1000. The main memory 1900 may communicate with the main processor 1700 and, as a non-transitory storage device, may store a plurality of instructions executed by the main processor 1700. For example, the main memory 1900 may include, as non-limiting examples, any type of memory capable of being accessed by the main processor 1700, such as RAM, ROM, tape, a magnetic disk, an optical disk, volatile memory, non-volatile memory, and a combination thereof.

An IDD operation, described with reference to FIGS. 1 to 9, according to an embodiment may be performed by at least one of the components of the communication device 1000 of FIG. 10. In some embodiments, at least one operation of the IDD operation described above may be implemented as a plurality of instructions stored in the memory 1500. In some embodiments, the ASIP 1300 may execute the plurality of instructions stored in the memory 1500, thereby performing at least one of the operations of the aforementioned method.

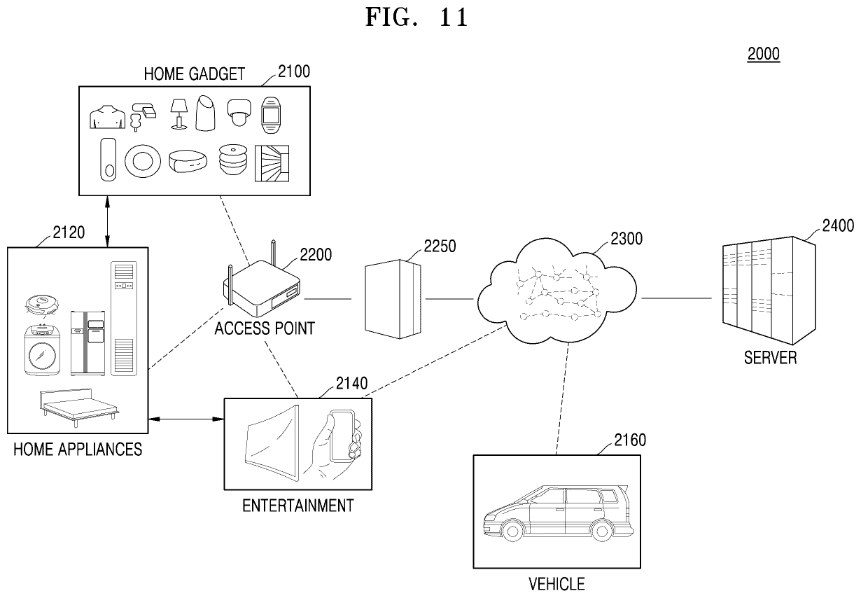

FIG. 11 is a conceptual diagram illustrating an Internet-of-Things (IOT) network system to which an embodiment is applied.

Referring to FIG. 11, an IoT network system 2000 may include a plurality of IoT devices (that is, 2100, 2120, 2140, and 2160), an access point 2200, a gateway 2250, a wireless network 2300, and a server 2400. IoT may refer to a network between things using wired/wireless communication.

Each of the IoT devices (that is, 2100, 2120, 2140, and 2160) may form a group, depending on characteristics of each IoT device. For example, the IoT devices may be grouped into a home gadget group 2100, a home appliance/furniture group 2120, an entertainment group 2140, a vehicle group 2160, or the like. A plurality of IoT devices (that is, 2100, 2120, and 2140) may be connected to a communication network or another IoT device via the access point 2200. The access point 2200 may be embedded in one IoT device. The gateway 2250 may change a protocol such that the access point 2200 is connected to an external wireless network. The IoT devices (that is, 2100, 2120, and 2140) may be connected to the external communication network via the gateway 2250. The wireless network 2300 may include the Internet and/or a public network. The plurality of IoT devices (that is, 2100, 2120, 2140, and 2160) may be connected, via the wireless network 2300, to the server 2400 providing a certain service, and a user may use the service via at least one of the plurality of IoT devices (that is, 2100, 2120, 2140, and 2160).

In some embodiments, each of the plurality of IoT devices (that is, 2100, 2120, 2140, and 2160) may receive a signal including a symbol from the transmitter 100 of FIG. 1, and when each of the plurality of IoT devices (that is, 2100, 2120, 2140, and 2160) performs N iterative operations, a first iterative operation from among the N iterative operations may include an operation of generating a first LLR based on the received symbol by a linear detection method and performing a first decoding operation based on the first LLR. The last iterative operation (or an N-th iterative operation) from among the N iterative operations may include an operation of generating a second LLR, based on the received symbol and on an output (for example, a post-log-likelihood ratio) generated in a decoding operation of an N-1-th iterative operation, by a nonlinear detection method and performing a second decoding operation based on the second LLR. Therefore, because each of the plurality of IoT devices (that is, 2100, 2120, 2140, and 2160) uses the linear detection method having relatively low complexity for LLR generation in the first iterative operation and uses the nonlinear detection method having relatively high complexity for LLR generation in the last iterative operation, performance deterioration in an initial detection operation may be prevented while reducing the power consumption and complexity in the initial detection operation. In some embodiments, the plurality of IoT devices (that is, 2100, 2120, 2140, and 2160) may each perform the IDD operation described above with reference to FIGS. 1 to 9.

While the inventive concept has been particularly shown and described with reference to embodiments thereof, it will be understood that various changes in form and details may be made therein without departing from the spirit and scope of the following claims.

What is claimed is:

1. An iterative detection and decoding (IDD) circuit configured to receive a signal including a symbol, the IDD circuit comprising:
a first detector configured to generate a first log-likelihood ratio based on the symbol by using a linear detection method;
a decoding circuit configured to perform a first decoding operation based on the first log-likelihood ratio and to generate a post-log-likelihood ratio when the first decoding operation fails; and
a second detector configured to, when the first decoding operation fails, generate a second log-likelihood ratio based on the symbol and the post-log-likelihood ratio by using a nonlinear detection method,
wherein the decoding circuit is further configured to perform a second decoding operation based on the second log-likelihood ratio.

2. The IDD circuit of claim 1, wherein the IDD circuit is further configured to perform N iterative operations, where N is an integer of 2 or more,
a first iterative operation from among the N iterative operations comprises a first detection operation for generating the first log-likelihood ratio by the first detector and the first decoding operation, and
a last iterative operation from among the N iterative operations comprises a second detection operation for generating the second log-likelihood ratio by the second detector and the second decoding operation.

3. The IDD circuit of claim 1, wherein the decoding circuit comprises:
a first circuit configured to generate a pre-log-likelihood ratio by performing a de-interleaving operation and a rate de-matching operation based on at least one of the first log-likelihood ratio and the second log-likelihood ratio;
a second circuit configured to generate a third log-likelihood ratio by performing an interleaving operation and a rate matching operation based on the post-log-likelihood ratio; and
a soft-input and soft-output (SISO) decoder configured to perform at least one of the first decoding operation and the second decoding operation based on the pre-log-likelihood ratio.

4. The IDD circuit of claim 1, wherein the decoding circuit is further configured to perform a cyclic redundancy check (CRC) operation, and to determine that a failure of the CRC operation indicates a failure of the first decoding operation.

5. The IDD circuit of claim 1, wherein the linear detection method comprises a method of generating the first log-likelihood ratio by using a linear detection matrix that comprises at least one of a minimum mean square error (MMSE) weight matrix, a zero forcing (ZF) weight matrix, and a QR decomposition (QRD) weight matrix.

6. The IDD circuit of claim 1, wherein the nonlinear detection method comprises a method of generating the second log-likelihood ratio by using at least one of a maximum likelihood (ML) algorithm and a near-ML algorithm.

7. The IDD circuit of claim 6, wherein the second detector is further configured to generate the second log-likelihood ratio based on the first log-likelihood ratio and the post-log-likelihood ratio, when the nonlinear detection method comprises a method of generating the second log-likelihood ratio by using the near-ML algorithm.

8. The IDD circuit of claim 1, wherein the nonlinear detection method comprises a method of searching for an initial point, selecting K candidates based on the initial point, and generating the second log-likelihood ratio based on at least one of Euclidean distances between the K candidates and the initial point, where K is a positive integer.

9. The IDD circuit of claim 8, wherein the initial point is searched for by using the first detector.

10. An operation method of an iterative detection and decoding (IDD) circuit, the operation method comprising:
receiving a signal including a symbol; and
performing N iterative operations, where N is an integer of 2 or more,
wherein a first iterative operation from among the N iterative operations comprises:
generating a first log-likelihood ratio based on the symbol by using a linear detection method;
performing a first decoding operation based on the first log-likelihood ratio;
terminating the N iterative operations, when the first decoding operation is successful; and
generating a post-log-likelihood ratio based on the first log-likelihood ratio, when the first decoding operation fails, and
an N-th iterative operation from among the N iterative operations comprises:
generating a second log-likelihood ratio based on the symbol and the post-log-likelihood ratio by using a nonlinear detection method; and
performing a second decoding operation based on the second log-likelihood ratio.

11. The operation method of claim 10, wherein the performing of the first decoding operation further comprises:
performing a cyclic redundancy check (CRC) operation; and
determining that a failure of the CRC operation indicates a failure of the first decoding operation.

12. The operation method of claim 10, wherein the linear detection method comprises a method of generating the first log-likelihood ratio by using a linear detection matrix that comprises at least one of a minimum mean square error (MMSE) weight matrix, a zero forcing (ZF) weight matrix, and a QR decomposition (QRD) weight matrix.

13. The operation method of claim 10, wherein the nonlinear detection method comprises a method of generating the second log-likelihood ratio by using at least one of a maximum likelihood (ML) algorithm and a near-ML algorithm.

14. The operation method of claim 10, wherein the generating of the second log-likelihood ratio based on the symbol and the post-log-likelihood ratio by using the nonlinear detection method comprises:
searching for an initial point;
selecting K candidates based on the initial point, where K is a positive integer; and
generating the second log-likelihood ratio based on at least one of Euclidean distances between the K candidates and the initial point.

15. The operation method of claim 14, wherein the searching for of the initial point comprises searching for the initial point based on the linear detection method.

16. A modem chip comprising:
a radio-frequency integrated circuit (RFIC); and
a processor configured to receive, via the RFIC, a reception signal including a symbol,
wherein the processor is further configured to:
generate a first log-likelihood ratio based on the symbol by using a linear detection method;
perform a first decoding operation based on the first log-likelihood ratio;
generate a post-log-likelihood ratio, when the first decoding operation fails;
generate a second log-likelihood ratio based on the symbol and the post-log-likelihood ratio by using a nonlinear detection method, when the first decoding operation fails; and
perform a second decoding operation based on the second log-likelihood ratio.

17. The modem chip of claim 16, wherein the processor is further configured to perform N iterative operations, where N is an integer of 2 or more,
a first iterative operation from among the N iterative operations comprises a first detection operation for generating the first log-likelihood ratio and the first decoding operation, and
an N-th iterative operation from among the N iterative operations comprises a second detection operation for generating the second log-likelihood ratio and the second decoding operation.

18. The modem chip of claim 16, wherein the linear detection method comprises a method of generating the first log-likelihood ratio by using a linear detection matrix that comprises at least one of a minimum mean square error (MMSE) weight matrix, a zero forcing (ZF) weight matrix, and a QR decomposition (QRD) weight matrix.

19. The modem chip of claim 16, wherein the nonlinear detection method comprises a method of searching for an initial point, selecting K candidates based on the initial point, and generating the second log-likelihood ratio based on at least one of Euclidean distances between the K candidates and the initial point, where K is a positive integer.

20. The modem chip of claim 19, wherein the initial point is searched for based on a first detection operation for generating the first log-likelihood ratio.
